(19) United States
(12) Patent Application Publication
(10) Pub. No.: US 2025/0094792 A1
(43) Pub. Date: Mar. 20, 2025

(54) TASK EXECUTION METHOD FOR LARGE MODEL, DEVICE, AND MEDIUM

(71) Applicant: Beijing Baidu Netcom Science Technology Co., Ltd., Beijing (CN)

(72) Inventors: Bo KE, Beijing (CN); Xuyi CHEN, Beijing (CN); Zhengjie HUANG, Beijing (CN); Shikun FENG, Beijing (CN); Weibin LI, Beijing (CN); Shiwei HUANG, Beijing (CN)

(21) Appl. No.: 18/968,790

(22) Filed: Dec. 4, 2024

(30) Foreign Application Priority Data
Jun. 17, 2024 (CN) 202410781150.4

(51) Int. Cl. G06N 3/0495; G06N 3/0475; G06N 3/0499; G06N 3/09

(52) U.S. Cl. CPC G06N 3/0495; G06N 3/0475; G06N 3/0499; G06N 3/09

(57) ABSTRACT

A task execution method for a large model, an electronic device, and a storage medium are provided, which relate to a field of artificial intelligence technology, particularly to fields of deep learning technology and large model technology. The method includes: executing a modality routing task by using a target computing unit based on a target feature to be processed to obtain a modality recognition result; executing a field routing task by using the target computing unit based on the target feature to be processed and a target field gating model parameter to obtain a field recognition result; and executing a feedforward task by using the target computing unit based on the target feature to be processed and a target feedforward task model parameter to obtain a task execution result

### CROSS-REFERENCE TO RELATED APPLICATION(S)

This application claims the benefit of Chinese Patent Application No. 202410781150.4 filed on Jun. 17, 2024, the whole disclosure of which is incorporated herein by reference.

### TECHNICAL FIELD

The present disclosure relates to a field of artificial intelligence technology, particularly to fields of deep learning technology and large model technology, and specifically to a task execution method for a large model, an electronic device, and a storage medium.

### BACKGROUND

Artificial intelligence technology is a comprehensive discipline that involves a wide range of fields, including both hardware and software technologies. Artificial intelligence technology generally includes large model technology. Large model technology may be widely applied in various fields of artificial intelligence, such as text processing, semantic understanding, machine translation, human-computer interaction, etc. When executing tasks in various fields using large models, it is required to comprehensively consider timeliness, cost and other factors.

### SUMMARY

The present disclosure provides a task execution method for a large model, an electronic device, and a storage medium.

According to an aspect of the present disclosure, a task execution method for a large model is provided, including: executing a modality routing task by using a target computing unit based on a target feature to be processed to obtain a modality recognition result; executing a field routing task by using the target computing unit based on the target feature to be processed and a target field gating model parameter to obtain a field recognition result, where the target field gating model parameter corresponds to the modality recognition result and is read from a target storage unit; and executing a feedforward task by using the target computing unit based on the target feature to be processed and a target feedforward task model parameter to obtain a task execution result, where the target feedforward task model parameter corresponds to the field recognition result and is read from the target storage unit.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method described above.

According to another aspect of the present disclosure, a non-transitory computer-readable storage medium having computer instructions therein is provided, and the computer instructions are configured to cause a computer to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a task execution method and apparatus for a large model may be applied according to an embodiment of the present disclosure;

FIG. 2 schematically shows a flowchart of a task execution method for a large model according to an embodiment of the present disclosure;

FIG. 3 shows a schematic structural diagram of a processing layer of a large model according to an embodiment of the present disclosure;

FIG. 4A schematically shows a schematic diagram of determining a large model according to an embodiment of the present disclosure;

FIG. 4B schematically shows a schematic diagram of determining a large model according to another embodiment of the present disclosure;

FIG. 5 schematically shows a block diagram of a task execution apparatus for a large model according to an embodiment of the present disclosure; and

FIG. 6 schematically shows a block diagram of an electronic device suitable for implementing a task execution method for a large model according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In a field of deep learning, applications of large models are constantly expanding. The large model may include, for example, a large language model (LLMs), a large image model, and a large audio model, etc. The large model demonstrates an exceptional task processing capability. However, it is generally difficult to ensure a superior processing efficiency of the large model while maintaining a high model performance.

The large model may be a pre-trained large model, and an architecture of the large model may be a Transformer architecture. The Transformer architecture has a powerful data processing capability and flexibility, and its applications in the field of natural language processing are constantly expanding. The large model having the Transformer architecture may include a plurality of processing layers. Each processing layer may have the same structure, including a module based on Multi Head self Attention (MHA) mechanism and a module based on Feed-Forward Network (FFN).

All parameters in each processing layer may process input data, and the parameters in the processing layer play different roles for input data with different field types and different modality types, which means that during each task execution, the entire large model needs to run, but only a small number of parameters actually function. In a case of parameter redundancy, the model may have a low inference efficiency.

Therefore, in order to ensure a superior inference efficiency of the large model while maintaining a high model performance, the present disclosure provides a task execution method for a large model, which will be described below.

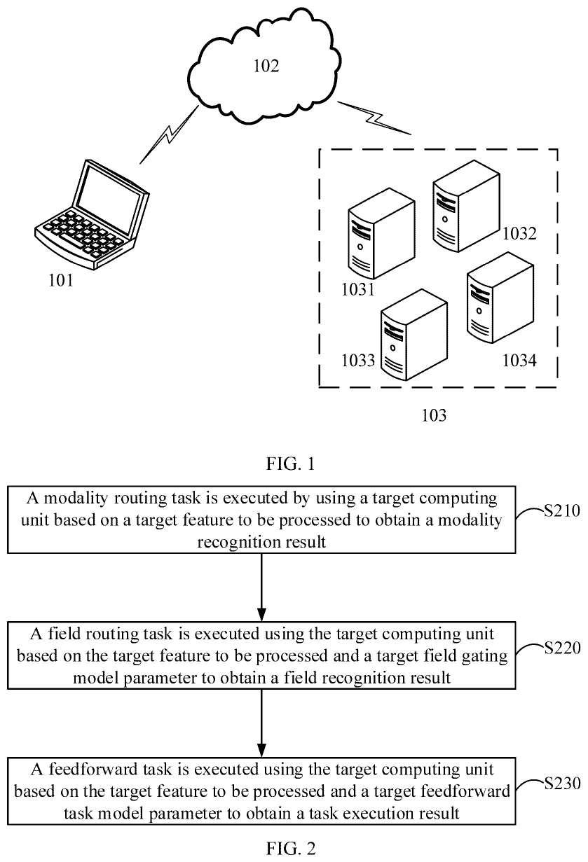

FIG. 1 schematically shows an exemplary system architecture to which a task execution method and apparatus for a large model may be applied according to an embodiment of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, the system architecture according to such embodiments may include a terminal device 101, a network 102, and a server cluster 103. The network 102 is a medium for providing a communication link between the terminal device 101 and the server cluster 103. The network 102 may also be a medium for providing a communication link within the server cluster 103. The network 102 may include various connection types, such as wired and/or wireless communication links, etc.

The terminal device 101 may be used by a user to interact with the server cluster 103 through the network 102 to receive or send messages, etc. For example, the terminal device 101 may send a request for training a deep learning model to the server cluster 103 through the network 102.

The terminal device 101 may be installed with various communication client applications, such as knowledge reading applications, web browser applications, search applications, instant messaging tools, email clients and/or social platform software, etc. (only for example).

The terminal device 101 may be various electronic devices having display screens and supporting web browsing, including but not limited to a smart phone, a tablet computer, a laptop computer, and a desktop computer, etc.

The server cluster 103 may be a server providing various services, such as a background management server (only for example) that provides a support for a request sent by the user using the terminal device 101.

The server cluster 103 may be a cloud server, also known as a cloud computing server or a cloud host, which is a host product in a cloud computing service system to solve shortcomings of difficult management and weak service scalability existing in a conventional physical host and VPS (Virtual Private Server) service. The server may also be a server of a distributed system or a server combined with a block-chain.

The server cluster 103 includes a plurality of server nodes 1031, 1032, 1033 and 1034, each of which includes one or more hardware devices. The server cluster 103 or the server nodes may be used to perform the task execution method for the large model provided in the present disclosure to achieve the deployment, inference or training of the large model with few computing resources.

It may be understood that the system architecture of the present disclosure has been described above, and the method of the present disclosure will be described below.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

FIG. 2 schematically shows a flowchart of a task execution method for a large model according to an embodiment of the present disclosure.

As shown in FIG. 2, the method includes operations S210 to S230.

In operation S210, a modality routing task is executed by using a target computing unit based on a target feature to be processed to obtain a modality recognition result.

In embodiments of the present disclosure, the target computing unit may include at least one of a central processing unit (CPU), a graphics processing unit (GPU) or an artificial intelligence computing unit. The artificial intelligence computing unit may include at least one of a neural processing unit (NPU), a tensor processing unit (TPU), or a Kunlun core, etc.

In embodiments of the present disclosure, a processing layer of the large model may include a modality router. The modality router is used to perform a modality recognition on the target feature to be processed to obtain the modality recognition result. The modality router may be used to perform a modality recognition on the target feature to be processed. The modality router may be implemented using a linear layer such as Softmax. It is possible to process the target feature to be processed by using the target computing unit based on a modality routing model parameter of the modality router to obtain the modality recognition result, so as to complete the modality routing task.

In embodiments of the present disclosure, the modality recognition result may represent a modality type of the target feature to be processed. For example, the modality type of the target feature to be processed may include at least one of text, image, or audio.

In operation S220, a field routing task is executed using the target computing unit based on the target feature to be processed and a target field gating model parameter to obtain a field recognition result.

In embodiments of the present disclosure, the field router in the processing layer of the large model is used to perform a field recognition on the target feature to be processed to obtain the field recognition result. The field router may also be implemented using a linear layer such as Softmax. It is possible to execute the field routing task for the target feature to be processed by using the target computing unit based on a target field gating model parameter to obtain the field recognition result.

In embodiments of the present disclosure, the field recognition result may represent a field type of the target feature to be processed. For example, the field type of the target feature to be processed may include at least one of translation, query answering, retrieval, text generation, or intent recognition.

In embodiments of the present disclosure, each processing layer of the large model may be configured with a plurality of field gates, such as Router1, Router2 and Router3. Each field gate corresponds to a modality type. For example, Router1 corresponds to a text modality type, Router2 corresponds to an image modality type, and Router3 corresponds to an audio modality type.

In embodiments of the present disclosure, the target field gating model parameter may be a field gating model parameter corresponding to the modality recognition result, which is read from a target storage unit. For example, Router1, Router2 and Router3 may have respective field gating model parameters stored in the target storage unit. In a case that the modality recognition result represents that the modality type of the data to be processed is a text modality type, the field gating model parameter of Router1 may be read from the target storage unit as the target field gating model parameter.

In operation S230, a feedforward task is executed using the target computing unit based on the target feature to be processed and a target feedforward task model parameter to obtain a task execution result.

In embodiments of the present disclosure, the processing layer of the large model may include a plurality of modality expert modules, each of which is matched with a modality type. Each modality expert module includes a plurality of field expert sub-modules, each of which is matched with a field type.

In embodiments of the present disclosure, each field expert sub-module may include at least one feedforward neural network. Each field expert sub-module is used to process the target feature to be processed, for example, perform vector mapping, to obtain the task execution result. It is possible to execute a feedforward task on the target feature to be processed by using the target computing unit based on the target feedforward task model parameter of the target field expert sub-module to obtain the task execution result.

In embodiments of the present disclosure, each processing layer of the large model may be configured with a plurality of modality expert modules corresponding to a modality type, such as modality expert modules Expert1, Expert1 and Expert1. Each modality expert module may include a plurality of field expert sub-modules. For example, the modality expert module Expert1 includes field expert sub-modules Expert1-1, Expert1-2 and Expert1-3. Each field expert sub-module corresponds to a field type. For example, the field expert sub-module Expert 1-1 corresponds to a query answering field type, the field expert sub-module Expert 1-2 corresponds to a retrieval field type, and the field expert sub-module Expert1-3 corresponds to a translation field type.

In embodiments of the present disclosure, the target feedforward task model parameter corresponds to the field recognition result and is read from the target storage unit. For example, the field expert sub-modules Expert1-1, Expert1-2 and Expert1-3 may have respective feedforward task model parameters stored in the target storage unit. In a case that the modality recognition result represents that the modality type of the data to be processed is the query answering field type, the target feedforward task model parameter may be the feedforward task model parameter of the field expert sub-module Expert 1-1.

Through embodiments of the present disclosure, in the processing layer of the large model, a plurality of field expert sub-modules are combined through ensemble learning to form a plurality of modality expert modules, which may process data with different modality types, thereby improving an application ability and an application range of the large model, and improving a universality of the large model. In addition, each field expert sub-module focuses on solving a feedforward task with a specific field type under a specific modality type, thereby improving a fine-grained application of the large model and improving a pertinence of the large model. In addition, in a case of executing a feedforward task with a specific field type under a modality type, it is only needed to execute a feedforward task using the target computing unit based on the target feedforward task model parameter, and there is no need to use all the feedforward task model parameters in all field expert sub-modules, thereby improving a processing efficiency of the target computing unit while reducing hardware resource requirements and energy consumption of the target computing unit. In addition, a modality gate, a plurality of field gates and a plurality of modality expert modules are combined to form a complete processing layer. The modality gate may be used to dynamically match a target field gate according to data characteristics of the target feature to be processed, and the target field gate may be used to dynamically match a target field expert sub-module under the target modality expert module according to the data characteristics of the target feature to be processed, so that the inference performance of the activated target feedforward task model parameter may be improved. As a result, the inference performance may be improved while ensuring the inference efficiency of the large model.

It may be understood that an overview of the method of the present disclosure is given above, and the task execution method for the large model of the present disclosure will be further described below.

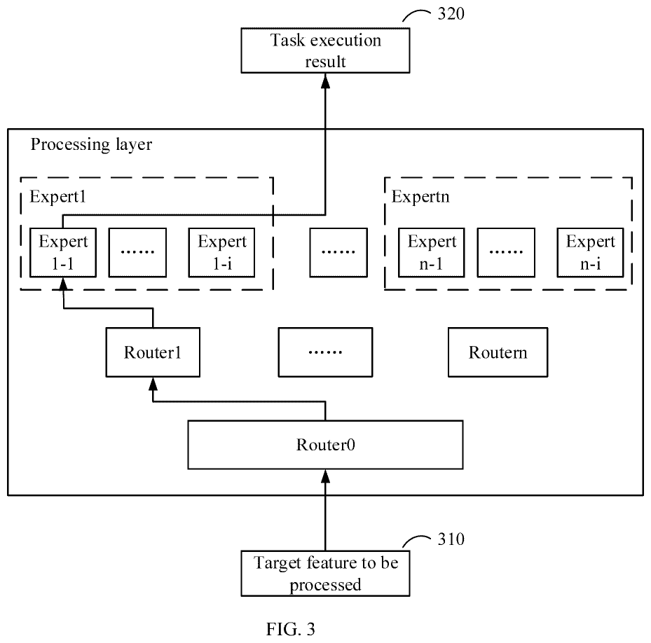

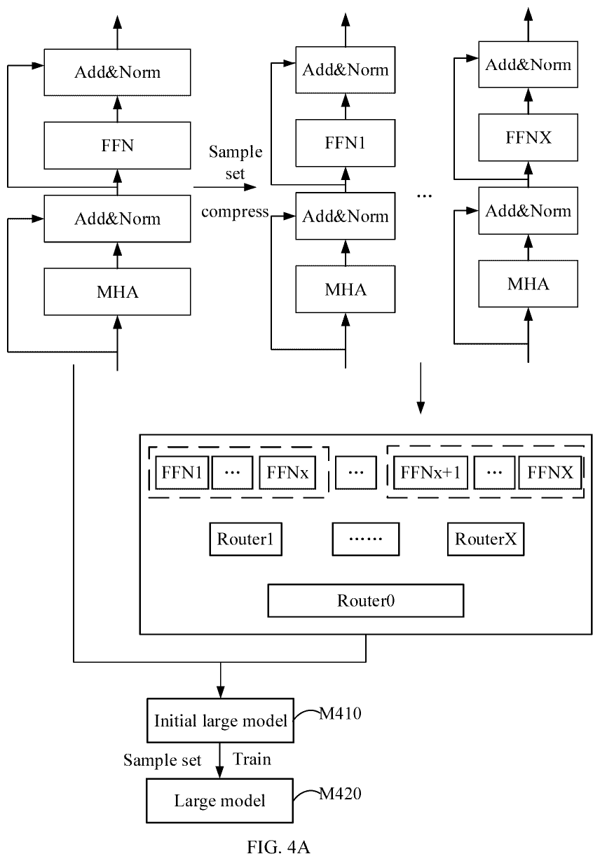

FIG. 3 shows a schematic structural diagram of a processing layer of a large model according to an embodiment of the present disclosure.

As shown in FIG. 3, a single processing layer of the large model includes a modality gate Router0, a first field gate Router1, a second field gate Router2, . . . , an n^{th} field gate Routern, a first modality expert module Expert1, a second modality expert module Expert2, . . . , an n^{th} modality expert module Expertn. The first modality expert module Expert1 corresponding to the first field gate Router1 includes a first field expert sub-module Expert1-1, a second field expert sub-module Expert1-2, . . . , an i^{th} field expert sub-module Expert1-i. The second modality expert module Expert2 corresponding to the second field gate Router2 includes a first field expert sub-module Expert2-1, a second field expert sub-module Expert2-2, . . . , an i^{th} field expert sub-module Expert2-i. The n^{th} modality expert module Expertn corresponding to the n^{th} field gate Routern includes a first field expert sub-module Expertn-1, a second field expert sub-module Expertn-2, . . . , an i^{th} field expert sub-module Expertn-i.

The respective field gating model parameters of the first field gate Router1, the second field gate Router2, . . . , the n^{th} field gate Routern correspond to different modality types.

The respective feedforward task model parameters of the plurality of field expert sub-modules corresponding to the same field gate correspond to different field types.

The modality gating model parameter, the plurality of field gating model parameters and the plurality of feedforward task model parameters may be pre-stored in the target storage unit.

As shown in FIG. 3, the modality routing task may be executed by using the target computing unit based on a target feature 310 to be processed and a modality gating model parameter of the modality gate stored in the target storage unit, so as to obtain a modality recognition result. For example, the modality recognition result represents that the modality type of the target feature to be processed corresponds to the first field gate Router1. The field routing task may be executed using the target computing unit based on the target feature to be processed and the target field gating model parameter of the first field gate Router1, so as to obtain a field recognition result. For example, the field recognition result represents that the field type of the target feature to be processed corresponds to the first field expert sub-module Expert1-1. The feedforward task may be executed using the target computing unit based on the target feature to be processed and the target feedforward task model parameter of the first field expert sub-module Expert1-1, so as to obtain a task execution result 320.

According to embodiments of the present disclosure, the task execution method for the large model may further include: obtaining a target field gating model parameter from a plurality of field gating model parameters stored in the target storage unit based on the modality recognition result; and executing the field routing task using the target computing unit based on the target feature to be processed and the target field gating model parameter, so as to obtain the field recognition result.

According to embodiments of the present disclosure, the task execution method for the large model may further include: obtaining a target feedforward task model parameter from a plurality of feedforward task model parameters stored in the target storage unit based on the field recognition result; and executing the feedforward task using the target computing unit based on the target feature to be processed and the target feedforward task model parameter to obtain the task execution result.

In embodiments of the present disclosure, the input data of the large model may be data to be processed with the modality type as text and the field type as query answering, which is processed by a pre-processing layer of the processing layer to obtain the target feature to be processed. The task execution result obtained by the task execution method provided by embodiments of the present disclosure may be used to obtain an output result of the large model, and the output result may be an answer that corresponds to the data to be processed.

According to embodiments of the present disclosure, the modality type may include at least one of image, text, or audio. The field type may include at least one of translation data, query answering data, retrieval data, text generation data, or intent recognition data.

In other embodiments, the processing layer of the large model may consist of two parts, namely a gating network and an expert module. The expert module may include first expert modules Expert1-1, Expert2-1, . . . , Expertn-1, second expert modules Expert1-2, Expert2-2, . . . , Expertn-2, i^{th} expert modules Experti-1, Experti-2, . . . , Experti-n. The gating network is used to dynamically determine which expert module is to be activated to generate an optimal prediction based on characteristics of the target feature to be processed. The target expert module may be determined from the plurality of expert modules based on a result output by the gating network. Then, the target feature to be processed may be processed using the target computing unit based on the model parameters of the target expert module, so as to obtain the task execution result.

Compared with the task execution method using one gating network, the task execution method provided in embodiments of the present disclosure may be performed to determine the target field gating model parameter by executing the modality routing task, so as to complete a modality classification of the target feature to be processed, and determine the target feedforward task model parameter by executing the field routing task, so as to complete a field classification of the target feature to be processed. Through two-level type recognition, it is possible to obtain an accurate and valid target feedforward task model parameter from the plurality of feedforward task model parameters, so as to improve an inference accuracy and an inference efficiency of the task execution method for the large model.

It may be understood that a network structure of the processing layer of the large model has been described above. A method of acquiring a model parameter of the processing layer will be further described below.

In embodiments of the present disclosure, the task execution method for the large model may be applied to any service node of the server. However, the present disclosure is not limited to this, and the task execution method for the large model may also be applied to the terminal device.

In embodiments of the present disclosure, the task execution method for the large model may further include an operation of acquiring a model parameter.

For example, a model acquisition request may be sent to the server using an interface. In response to receiving a plurality of feedforward task model parameters and a plurality of field gating model parameters corresponding to the model acquisition request, the plurality of feedforward task model parameters and the plurality of field gating model parameters may be stored in the target storage unit.

In embodiments of the present disclosure, the terminal device may send a model acquisition request to the server through an interface. After receiving the model acquisition request from the terminal device, the server may send a model parameter of the large model, such as a modality gating model parameter, a plurality of feedforward task model parameters and a plurality of field gating model parameters, to the terminal device through the interface. In response to receiving the model parameters, the terminal device may store the modality gating model parameter, the plurality of feedforward task model parameters and the plurality of field gating model parameters into the target storage unit, so that the corresponding model parameters may be acquired from the target storage unit in a process of executing the task using the target computing unit.

In embodiments of the present disclosure, the model acquisition request may include a model performance requirement. The model performance requirement may include at least one of a model accuracy, a model latency, an energy consumption of the target computing unit, and a quantity of model parameters. However, the present disclosure is not limited to this, and the model acquisition request may further include the field type of the field expert sub-module and/or the modality type of the field gate.

In embodiments of the present disclosure, the plurality of feedforward task model parameters corresponding to the model acquisition request may include a feedforward task model parameter and a plurality of field gating model parameters that meet the model performance requirement.

Through the task execution method for the large model provided in embodiments of the present disclosure, it is possible to generate a model acquisition request for hardware of the terminal device, such as a resource allocation of the target computing unit, a user demand, etc. The model parameters matched with the hardware resources of the terminal device or the user demand may be obtained based on the model acquisition request and successfully applied to the terminal device, so that the flexibility and pertinence of the task execution method for the large model may be improved, and satisfaction of personalized requirements may be improved.

The method of acquiring the model parameter has been described above. An acquisition and optimization of the feedforward task model parameter will be further described below.

According to embodiments of the present disclosure, the plurality of feedforward task model parameters may be obtained as follows.

For example, a plurality of target compressed large models are obtained based on a sample set and a pre-trained large model, and the plurality of feedforward task model parameters are obtained based on the plurality of target compressed large models.

In embodiments of the present disclosure, the pre-trained large model may include a pre-trained large model containing a Transformer structure, and the pre-trained large model may include model parameters to be compressed having the same function as the feedforward task model parameters. For example, the model parameters to be compressed may include model parameters used to execute the feedforward task, such as FFN model parameters. A parameter quantity of the model parameters to be compressed is greater than a parameter quantity of the feedforward task model parameters.

In embodiments of the present disclosure, the sample set may include a plurality of sample sub-sets with different field types. For example, the sample set may include a sub-set of query answering samples with the text type, a sub-set of retrieval samples with the text type, a sub-set of translation samples with the text type, a sub-set of query answering samples with the audio type, a subset of retrieval samples with the audio type, a sub-set of translation samples with the audio type, a sub-set of query answering samples with the image type, a sub-set of retrieval samples with the image type, and a sub-set of translation samples with the image type.

In embodiments of the present disclosure, a compression task may be executed using a computing unit based on the plurality of sample sub-sets and the same pre-trained large model, so as to obtain a plurality of target compressed large models corresponding to the plurality of sample sub-sets.

In embodiments of the present disclosure, the compression task may refer to compressing, such as clipping or light-weighting, predetermined parameters in the pre-trained large model, such as the model parameters to be compressed, by using the sample set, so as to obtain a target compressed large model that inherits knowledge and capability of the pre-trained large model and that has a quantity of model parameters less than a quantity of the model parameters of the pre-trained large model.

In embodiments of the present disclosure, the plurality of target compressed large models each maintain the same backbone as the pre-trained large model, but have different FFN model parameters used to execute the feedforward task. For example, the FFN model parameters used to execute the feedforward task in the target compressed large model correspond to a sample sub-set.

In embodiments of the present disclosure, the respective FFN model parameters of the plurality of target compressed large models may be used as the plurality of feedforward task model parameters.

Through the compression method for the target compressed large model provided in embodiments of the present disclosure, the model parameters to be compressed may be compressed so that the model parameters of the target compressed large model obtained by compression have a small parameter quantity and well inherit the knowledge and inference ability of the model parameters to be compressed. In addition, through the plurality of sample sub-sets with different field types, the target compressed large model may inherit the inference ability and knowledge of different field types under different modality types of the pre-trained large model.

In embodiments of the present disclosure, obtaining the plurality of target compressed large models based on the sample set and the pre-trained large model may include the following operations.

For example, for each sample sub-set, a compressed large model is obtained based on a clipping matrix and the pre-trained large model, and the target compressed large model is obtained based on the sub-set of compressed samples, the pre-trained large model and the compressed large model.

In embodiments of the present disclosure, the clipping matrix may be used to indicate a method of clipping the model parameters to be compressed. The clipping matrix Z may include a plurality of clipping elements, each of which may be represented by 0 or 1. Each clipping element corresponds to a model parameter among the model parameters to be compressed, where 0 indicates that the model parameter is clipped out, and 1 indicates that the model parameter is retained.

In embodiments of the present disclosure, the clipping matrix may be vector multiplied with the model parameters of the pre-trained large model to obtain the compressed large model. The target compressed large model may be obtained based on the sample sub-set, the pre-trained large model and the compressed large model.

Obtaining the target compressed large model based on the sample sub-set, the pre-trained large model and the compressed large model may include the following operations: executing a cyclic compression task by using the computing unit based on the sample sub-set, the pre-trained large model and the compressed large model, so as to obtain the target compressed large model.

In embodiments of the present disclosure, the cyclic compression task may include: determining a compressed large model as the target compressed large model when it is determined based on the sample sub-set that a model performance of the pre-trained large model is matched with a model performance of the compressed large model; updating the clipping matrix when it is determined based on the sample sub-set that the model performance of the pre-trained large model is not matched with the model performance of the compressed large model, so as to obtain an updated compressed large model; and repeatedly executing the cyclic compression task by using the updated compressed large model, the sample sub-set and the pre-trained large model until the model performance of the pre-trained large model is matched with the model performance of the compressed large model.

By compressing the pre-trained large model using the clipping matrix provided in embodiments of the present disclosure, the whole compression process may be analyzed and the compression efficiency may be improved. In addition, by compressing the pre-trained large model separately using the plurality of sample sub-sets with different field types, the performance of the obtained target compressed large model may be improved, and the compression efficiency may be further improved.

In embodiments of the present disclosure, obtaining the target compressed large model based on the sample sub-set, the pre-trained large model and the compressed large model may include the following operations: determining a reference inference ability of the pre-trained large model and a verification inference ability of the compressed large model based on the sample sub-set; and determining the target compressed large model based on the compressed large model when the verification inference ability is matched with the reference inference ability.

For example, it is possible to process the sample data sub-set in the sample sub-set respectively using the pre-trained large model and the compressed large model, so as to obtain a first prediction result corresponding to the pre-trained large model and a second prediction result corresponding to the compressed large model. The reference inference ability may be obtained based on the first prediction result and a label sub-set corresponding to the sample data sub-set. The verification inference ability may be obtained based on the second prediction result and the label sub-set corresponding to the sample data sub-set. When a similarity between the verification inference ability and the reference inference ability is greater than a threshold, it is determined that the verification inference ability is matched with the reference inference ability.

When the similarity between the verification inference ability and the reference inference ability is less than or equal to the threshold, it is determined that the verification inference ability is not matched with the reference inference ability. Then it is possible to adjust the model parameters of the pre-trained large model and the clipping elements of the clipping matrix based on the reference inference ability and the verification inference ability, so as to obtain the updated pre-trained large model and the updated clipping matrix.

The compression task may be re-executed based on the sample sub-set, the updated pre-trained large model, and the clipping elements of the updated clipping matrix, until the reference inference ability is matched with the verification inference ability. The compressed large model obtained when the reference inference ability is matched with the verification inference ability may be used as the target compression large model.

In another embodiment of the present disclosure, it is also possible to provide a predetermined sparsity, which is used to indicate a predetermined clipping granularity. The predetermined sparsity may be determined based on an information carried in the model acquisition request.

Adjusting the model parameters of the pre-trained large model and the clipping elements of the clipping matrix based on the reference inference ability and the verification inference ability so as to obtain the updated pre-trained large model and the clipping elements of the updated clipping matrix may include: determining a sparsity based on the clipping matrix; determining a sparsity loss value based on the sparsity and a predetermined sparsity; and adjusting the model parameters of the pre-trained large model and the clipping elements of the clipping matrix based on the reference inference ability, the verification inference ability and the sparsity loss value, so as to obtain the updated pre-trained large model and the clipping elements of the updated clipping matrix.

In embodiments of the present disclosure, the sparsity loss value may be determined by using a loss function based on the sparsity and the predetermined sparsity. The reference inference ability may be obtained by using the loss function based on the first prediction result and the label sub-set corresponding to the sample data sub-set. The verification inference ability may be obtained by using the loss function based on the second prediction result and the label sub-set corresponding to the sample data sub-set. The loss function may be a cross-entropy loss function. However, the present disclosure is not limited to this, and it is also possible to use other functions that may represent a degree of match between two data to be measured.

The compression task is re-executed based on the sample sub-set, the updated pre-trained large model and the clipping elements of the updated clipping matrix until the reference inference ability is matched with the verification inference ability and the sparsity of the compressed large model meets the predetermined sparsity. The compressed large model obtained when the reference inference ability is matched with the verification inference ability and the sparsity of the compressed large model meets the predetermined sparsity is determined as the target compressed large model.

In embodiments of the present disclosure, the compressed model parameters corresponding to the model parameters to be compressed in the target compressed large model may be used as the feedforward task model parameters.

In the target compression large model obtained by the compression method provided in embodiments of the present disclosure, the model parameters of the target compressed large model are clipped model parameters with respect to the model parameters of the pre-trained large model and are lightweight model parameters, so that the parameter quantity of the model parameters of the target compressed large model may be reduced. In addition, with the sample sub-set as the compression sample, the pre-trained large model is trained while being compressed, so that the target compressed large model may inherit the model inference ability of the updated pre-trained large model for data with the field type under the modality type, and then the model inference ability of the target compressed large model may be improved.

In embodiments of the present disclosure, the plurality of feedforward model parameters obtained by the above method may be directly used as feedforward model parameters of the large model.

In another embodiment of the present disclosure, the plurality of feedforward model parameters obtained by the above method may also be used as a plurality of initial feedforward model parameters. An initial large model may be obtained based on the pre-trained large model, a plurality of initial field gating model parameters, a plurality of initial feedforward task model parameters and an initial modality gating model parameter. The initial modality gating model parameter has the same function as the model parameter used to execute the modality routing task, each initial field gating model parameter has the same function as the field gating model parameter, and each initial feedforward task model parameter has the same function as the feedforward task model parameter.

For example, obtaining the initial large model based on the pre-trained large model, the plurality of initial field gating model parameters, the plurality of initial feedforward task model parameters and the initial modality gating model parameter may include: replacing the model parameters to be compressed in the pre-trained large model with the plurality of initial field gating model parameters, the plurality of initial feedforward task model parameters and the initial modality gating model parameter, so as to obtain the initial large model. For example, the plurality of initial field gating model parameters, the plurality of initial feedforward task model parameters and the initial modality gating model parameter may be used as a mixed expert architecture to replace the FFN layer corresponding to the model parameters to be compressed in the pre-trained large model, so as to obtain the initial large model. The mixed expert architecture contains a plurality of hierarchical networks. It is possible to accurately locate the initial feedforward task model parameter by using multi-level routers in the plurality of hierarchical networks, so as to improve the inference efficiency through a small quantity of model parameters while ensuring the inference performance.

An optimization training may be performed on the initial large model to obtain a large model. Through the optimization training, a model combination adaptability of the mixed expert architecture may be further improved, so that the model inference performance of the large model may be further improved.

The optimization training performed on the initial large model to obtain the large model will be further explained below.

According to embodiments of the present disclosure, performing the optimization training on the initial large model to obtain the large model may include: obtaining a set of model output results based on the sample dataset of the sample set and the initial large model; obtaining a plurality of loss values based on the set of model output results and the label set; obtaining the large model based on the plurality of loss values and the initial large model; and determining the model parameter in the large model that have the same function as the feedforward task model parameter as the feedforward task model parameter.

The sample set may further include a label set matched with the sample dataset. The sample dataset includes a plurality of sample data sub-sets with different field types, and the initial large model includes model parameters that have the same function as the feedforward task model parameters.

In embodiments of the present disclosure, the sample dataset of the sample set may be input into the initial large model to obtain the set of model output results. The set of model output results and the label set may be input into the loss function to obtain a plurality of loss values. The large model may be obtained based on the plurality of loss values and the initial large model. The plurality of loss values correspond to the plurality of sample data sub-sets respectively.

A type of the loss function is not limited here, which may include a cross-entropy loss function, as long as the loss function may be used to determine the loss value.

According to embodiments of the present disclosure, obtaining the feedforward task model parameter based on the plurality of loss values and the initial large model may include: obtaining a target loss value based on the plurality of loss values; and obtaining the feedforward task model parameter based on the target loss value and the initial large model.

Obtaining the target loss value based on the plurality of loss values may include: performing a weighted summation on the plurality of loss values to obtain the target loss value. When it is determined that the target loss value does not converge, the initial large model may be adjusted. When it is determined that the target loss value converges, the initial large model with the target loss value converging may be determined as the large model. The model parameters corresponding to the initial feedforward task model parameters in the large model may be used as the feedforward task model parameters.

Through the mixed training method described above, it is possible to perform mixed fine-tuning on the entire mixed expert architecture by using the sample set, so as to improve the overall adaptability. Then a classification performance of the modality routing task parameter and the field routing task parameter may be improved while improving the inference efficiency and the inference performance of the feedforward task model parameter of the large model, so that the overall performance of the large model may be improved.

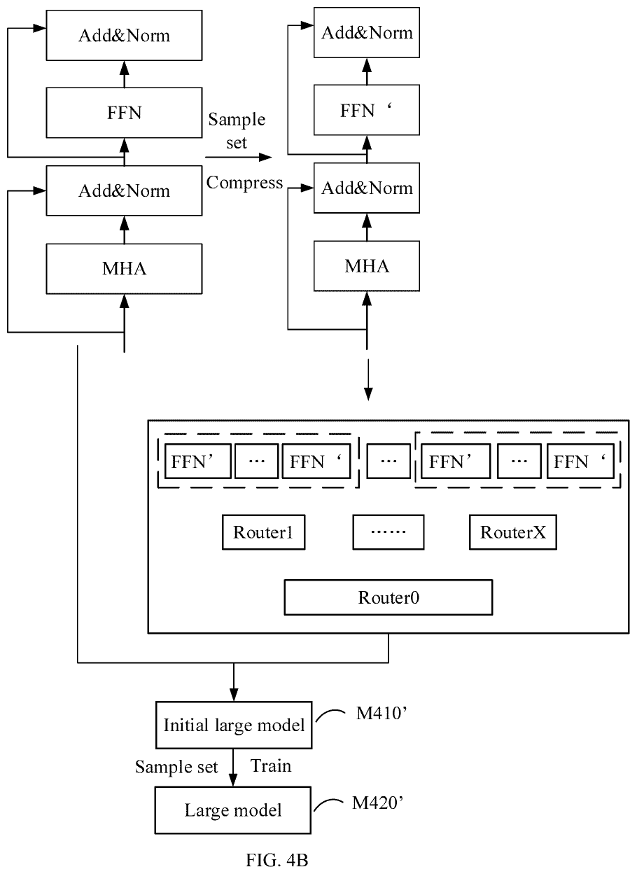

FIG. 4A schematically shows a schematic diagram of determining a large model according to an embodiment of the present disclosure.

As shown in FIG. 4A, a pre-trained large model may include a plurality of processing layers, each of which includes a multi-head attention module (MHA), an addition and normalization module (Add&Norm), and a feedforward module (FFN). The FFN model parameters of the pre-trained large model may be compressed using the sample set to obtain a plurality of target compressed large models. A plurality of initial feedforward task model parameters FFN1, . . . , FFNX may be obtained based on the plurality of target compressed large models.

As shown in FIG. 4A, the FFN model parameters in the pre-trained large model are replaced by a plurality of initial field gating model parameters Router1, . . . , RouterX, a plurality of initial feedforward task model parameters FFN1, . . . , FFNX, and an initial modality gating model parameter Router0, so as to obtain an initial large model M410.

As shown in FIG. 4A, an optimization training is performed on the initial large model 410 by using a sample set, so as to obtain a large model M420.

FIG. 4B schematically shows a schematic diagram of determining a large model according to another embodiment of the present disclosure.

As shown in FIG. 4B, the task execution method is similar to the task execution method shown in FIG. 4A, with the only difference that the FFN model parameters of the pre-trained large model are compressed using a sample sub-set in the sample set to obtain a lightweight large model matched with the sample sub-set, and the FFN parameters in the lightweight large model are copied to obtain a plurality of initial feedforward task parameters FFN′.

The FFN model parameters in the pre-trained large model may be replaced by the plurality of initial field gating model parameters, the plurality of initial feedforward task model parameters and the initial modality gating model parameter to obtain an initial large model M410′. The initial large model M410′ is trained using the sample set to obtain a large model M420′.

Compared with the method of determining the large model as shown in FIG. 4B, the method of determining the large model as shown in FIG. 4A may allow the plurality of initial feedforward task model parameters to well inherit the knowledge of the pre-trained large model before clipping, through the sample sub-sets with different types in the sample set, then the plurality of initial feedforward task model parameters have natural differentiation from each other, which is conducive to improving the training efficiency and training accuracy of mixed training.

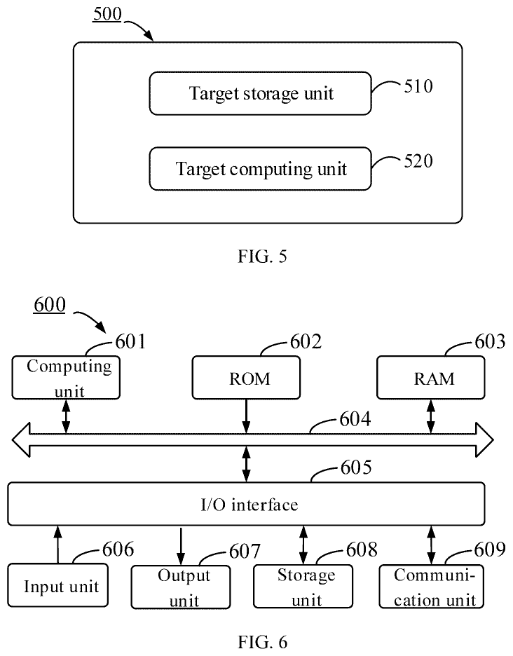

FIG. 5 schematically shows a block diagram of a task execution apparatus for a large model according to an embodiment of the present disclosure.

As shown in FIG. 5, a task execution apparatus 500 for a large model includes a target storage unit 510 and a target computing unit 520.

The target storage unit 510 has a plurality of field gating model parameters and a plurality of feedforward task model parameters stored thereon.

The target computing unit 520 is used to: execute a modality routing task by using a target computing unit based on a target feature to be processed to obtain a modality recognition result; execute a field routing task by using the target computing unit based on the target feature to be processed and a target field gating model parameter to obtain a field recognition result, where the target field gating model parameter corresponds to the modality recognition result and is read from a target storage unit; and execute a feedforward task by using the target computing unit based on the target feature to be processed and a target feedforward task model parameter to obtain a task execution result, where the target feedforward task model parameter corresponds to the field recognition result and is read from the target storage unit.

According to embodiments of the present disclosure, the task execution apparatus 500 for the large model further includes an actuator used to: obtain the target field gating model parameter from a plurality of field gating model parameters stored in the target storage unit based on the modality recognition result, where the plurality of field gating model parameters correspond to different modality types.

According to embodiments of the present disclosure, the actuator is further used to: obtain the target feedforward task model parameter from a plurality of feedforward task model parameters stored in the target storage unit based on the field recognition result, where the plurality of feedforward task model parameters correspond to different field types.

According to embodiments of the present disclosure, the target computing unit is further used to: obtain a plurality of target compressed large models based on a sample set and a pre-trained large model, where the sample set includes a plurality of sample sub-sets with different field types, and the pre-trained large model includes model parameters to be compressed having the same function as the feedforward task model parameters; and obtain the plurality of feedforward task model parameters based on the plurality of target compressed large models.

According to embodiments of the present disclosure, the obtaining a plurality of target compressed large models based on a sample set and a pre-trained large model includes: obtaining a compressed large model for each sample sub-set based on a clipping matrix and the pre-trained large model, where the clipping matrix is configured to indicate a method of clipping the model parameter to be compressed; and obtaining the target compressed large model based on the sample sub-set, the pre-trained large model and the compressed large model.

According to embodiments of the present disclosure, the obtaining the target compressed large model based on the sample sub-set, the pre-trained large model and the compressed large model includes: determining a reference inference ability of the pre-trained large model and a verification inference ability of the compressed large model based on the sample sub-set; and determining the target compressed large model based on the compressed large model when the verification inference ability is matched with the reference inference ability and a sparsity of the compressed large model meets a predetermined sparsity.

According to embodiments of the present disclosure, the target computing unit is further used to: obtain a model output result set based on an initial large model and a sample dataset of a sample set, where the sample set further includes a label set matched with the sample dataset, the sample dataset includes a plurality of sample data sub-sets with different field types, and the initial large model includes a model parameter having the same function as the feedforward task model parameter; obtain a plurality of loss values based on the model output result set and the label set, where the plurality of loss values correspond to the plurality of sample data sub-sets respectively; and obtain the feedforward task model parameter based on the plurality of loss values and the initial large model.

According to embodiments of the present disclosure, the obtaining the feedforward task model parameter based on the plurality of loss values and the initial large model includes: obtaining a target loss value based on the plurality of loss values; and obtaining the feedforward task model parameter based on the target loss value and the initial large model.

According to embodiments of the present disclosure, the target computing unit is further used to: obtain the initial large model based on a pre-trained large model, a plurality of initial field gating model parameters, a plurality of initial feedforward task model parameters and an initial modality gating model parameter, where the initial modality gating model parameter has the same function as a model parameter configured to execute the modality routing task, each initial field gating model parameter has the same function as the field gating model parameter, and each initial feedforward task model parameter has the same function as the feedforward task model parameter.

According to embodiments of the present disclosure, the modality type includes at least one of image, text or audio, and the field type includes at least one of translation, query answering, retrieval, text generation, or intent recognition.

According to embodiments of the present disclosure, the target computing unit is further used to: send a model acquisition request to a server by using an interface; store a plurality of feedforward task model parameters corresponding to the model acquisition request and a plurality of field gating model parameters corresponding to the model acquisition request in the target storage unit in response to receiving the plurality of feedforward task model parameters and the plurality of field gating model parameters.

According to embodiments of the present disclosure, the model acquisition request includes a model performance requirement, the plurality of feedforward task model parameters corresponding to the model acquisition request include a feedforward task model parameter meeting the model performance requirement, and the model performance requirement includes at least one of a model accuracy, a model latency, an energy consumption of the target computing unit, or a quantity of model parameters.

According to embodiments of the present disclosure, the present disclosure further provides an electronic device, a readable storage medium, and a computer program product.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions are used to, when executed by the at least one processor, cause the at least one processor to implement the method described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program is used to, when executed by a processor, cause the processor to implement the method described above

FIG. 6 shows a schematic block diagram of an example electronic device 600 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601 which may perform various appropriate actions and processes according to a computer program stored in a read only memory (ROM) 602 or a computer program loaded from a storage unit 608 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and processes described above, such as the task execution method for the large model. For example, in some embodiments, the task execution method for the large model may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the task execution method for the large model described above. Alternatively, in other embodiments, the computing unit 601 may be used to perform the task execution method for the large model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the task execution method for the large model of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A task execution method for a large model, comprising:
executing a modality routing task by using a target computing unit based on a target feature to be processed to obtain a modality recognition result;
executing a field routing task by using the target computing unit based on the target feature to be processed and a target field gating model parameter to obtain a field recognition result, wherein the target field gating model parameter corresponds to the modality recognition result and is read from a target storage unit; and
executing a feedforward task by using the target computing unit based on the target feature to be processed and a target feedforward task model parameter to obtain a task execution result, wherein the target feedforward task model parameter corresponds to the field recognition result and is read from the target storage unit.

2. The method according to claim 1, further comprising:
obtaining the target field gating model parameter from a plurality of field gating model parameters stored in the target storage unit based on the modality recognition result, wherein the plurality of field gating model parameters correspond to different modality types.

3. The method according to claim 1, further comprising:
obtaining the target feedforward task model parameter from a plurality of feedforward task model parameters stored in the target storage unit based on the field recognition result, wherein the plurality of feedforward task model parameters correspond to different field types.

4. The method according to claim 1, wherein the plurality of feedforward task model parameters are obtained by:
obtaining a plurality of target compressed large models based on a sample set and a pre-trained large model, wherein the sample set comprises a plurality of sample sub-sets with different field types, and the pre-trained large model comprises model parameters to be compressed having the same function as the plurality of feedforward task model parameters; and
obtaining the plurality of feedforward task model parameters based on the plurality of target compressed large models.

5. The method according to claim 4, wherein the obtaining a plurality of target compressed large models based on a sample set and a pre-trained large model comprises:
obtaining a compressed large model for each sample sub-set based on a clipping matrix and the pre-trained large model, wherein the clipping matrix is configured to indicate a method of clipping the model parameters to be compressed; and
obtaining the target compressed large model based on the sample sub-set, the pre-trained large model and the compressed large model.

6. The method according to claim 5, wherein the obtaining the target compressed large model based on the sample sub-set, the pre-trained large model and the compressed large model comprises:
determining a reference inference ability of the pre-trained large model and a verification inference ability of the compressed large model based on the sample sub-set; and
determining the target compressed large model based on the compressed large model when the verification inference ability is matched with the reference inference ability and a sparsity of the compressed large model meets a predetermined sparsity.

7. The method according to claim 1, wherein the feedforward task model parameter is obtained by:
obtaining a model output result set based on an initial large model and a sample dataset of a sample set, wherein the sample set further comprises a label set matched with the sample dataset, the sample dataset comprises a plurality of sample data sub-sets with different field types, and the initial large model comprises a model parameter having the same function as the feedforward task model parameter;
obtaining a plurality of loss values based on the model output result set and the label set, wherein the plurality of loss values correspond to the plurality of sample data sub-sets respectively; and
obtaining the feedforward task model parameter based on the plurality of loss values and the initial large model.

8. The method according to claim 7, wherein the obtaining the feedforward task model parameter based on the plurality of loss values and the initial large model comprises:
obtaining a target loss value based on the plurality of loss values; and
obtaining the feedforward task model parameter based on the target loss value and the initial large model.

9. The method according to claim 7, wherein the initial large model is obtained by:
obtaining the initial large model based on a pre-trained large model, a plurality of initial field gating model parameters, a plurality of initial feedforward task model parameters and an initial modality gating model parameter, wherein the initial modality gating model parameter has the same function as a model parameter configured to execute the modality routing task, each initial field gating model parameter has the same function as the field gating model parameter, and each initial feedforward task model parameter has the same function as the feedforward task model parameter.

10. The method according to claim 1, wherein the modality type comprises at least one of image, text or audio, and the field type comprises at least one of translation, query answering, retrieval, text generation, or intent recognition.

11. The method according to claim 1, further comprising:
sending a model acquisition request to a server by using an interface;
storing a plurality of feedforward task model parameters corresponding to the model acquisition request and a plurality of field gating model parameters corresponding to the model acquisition request in the target storage unit in response to receiving the plurality of feedforward task model parameters and the plurality of field gating model parameters.

12. The method according to claim 11, wherein the model acquisition request comprises a model performance requirement, the plurality of feedforward task model parameters corresponding to the model acquisition request comprise a feedforward task model parameter meeting the model performance requirement, and the model performance requirement comprises at least one of a model accuracy, a model latency, an energy consumption of the target computing unit, or a quantity of model parameters.

13. The method according to claim 2, further comprising:
obtaining the target feedforward task model parameter from a plurality of feedforward task model parameters stored in the target storage unit based on the field recognition result, wherein the plurality of feedforward task model parameters correspond to different field types.

14. The method according to claim 2, wherein the plurality of feedforward task model parameters are obtained by:
obtaining a plurality of target compressed large models based on a sample set and a pre-trained large model, wherein the sample set comprises a plurality of sample sub-sets with different field types, and the pre-trained large model comprises model parameters to be compressed having the same function as the plurality of feedforward task model parameters; and
obtaining the plurality of feedforward task model parameters based on the plurality of target compressed large models.

15. The method according to claim 14, wherein the obtaining a plurality of target compressed large models based on a sample set and a pre-trained large model comprises:
obtaining a compressed large model for each sample sub-set based on a clipping matrix and the pre-trained large model, wherein the clipping matrix is configured to indicate a method of clipping the model parameters to be compressed; and
obtaining the target compressed large model based on the sample sub-set, the pre-trained large model and the compressed large model.

16. The method according to claim 3, wherein the plurality of feedforward task model parameters are obtained by:
obtaining a plurality of target compressed large models based on a sample set and a pre-trained large model, wherein the sample set comprises a plurality of sample sub-sets with different field types, and the pre-trained large model comprises model parameters to be compressed having the same function as the plurality of feedforward task model parameters; and
obtaining the plurality of feedforward task model parameters based on the plurality of target compressed large models.

17. The method according to claim 16, wherein the obtaining a plurality of target compressed large models based on a sample set and a pre-trained large model comprises:
obtaining a compressed large model for each sample sub-set based on a clipping matrix and the pre-trained large model, wherein the clipping matrix is configured to indicate a method of clipping the model parameters to be compressed; and
obtaining the target compressed large model based on the sample sub-set, the pre-trained large model and the compressed large model.

18. The method according to claim 2, wherein the feedforward task model parameter is obtained by:
obtaining a model output result set based on an initial large model and a sample dataset of a sample set, wherein the sample set further comprises a label set matched with the sample dataset, the sample dataset comprises a plurality of sample data sub-sets with different field types, and the initial large model comprises a model parameter having the same function as the feedforward task model parameter;
obtaining a plurality of loss values based on the model output result set and the label set, wherein the plurality of loss values correspond to the plurality of sample data sub-sets respectively; and
obtaining the feedforward task model parameter based on the plurality of loss values and the initial large model.

19. An electronic device, comprising:
at least one processor; and
a memory communicatively connected to the at least one processor, wherein the memory stores instructions executable by the at least one processor, and the instructions, when executed by the at least one processor, are configured to cause the at least one processor to:
execute a modality routing task by using a target computing unit based on a target feature to be processed to obtain a modality recognition result;
execute a field routing task by using the target computing unit based on the target feature to be processed and a target field gating model parameter to obtain a field recognition result, wherein the target field gating model parameter corresponds to the modality recognition result and is read from a target storage unit; and
execute a feedforward task by using the target computing unit based on the target feature to be processed and a target feedforward task model parameter to obtain a task execution result, wherein the target feedforward task model parameter corresponds to the field recognition result and is read from the target storage unit.

20. A non-transitory computer-readable storage medium having computer instructions therein, wherein the computer instructions are configured to cause a computer to:
execute a modality routing task by using a target computing unit based on a target feature to be processed to obtain a modality recognition result;
execute a field routing task by using the target computing unit based on the target feature to be processed and a target field gating model parameter to obtain a field recognition result, wherein the target field gating model parameter corresponds to the modality recognition result and is read from a target storage unit; and
execute a feedforward task by using the target computing unit based on the target feature to be processed and a target feedforward task model parameter to obtain a task execution result, wherein the target feedforward task model parameter corresponds to the field recognition result and is read from the target storage unit.
